(19) United States
(12) Patent Application Publication
(10) Pub. No.: US 2026/0320925 A1
(43) Pub. Date: Oct. 15, 2026

(54) VIRTUAL SPACE CONTROL SYSTEM, VIRTUAL SPACE CONTROL METHOD, AND STORAGE MEDIUM

(71) Applicant: JVCKENWOOD Corporation, Yokohama-shi (JP)

(72) Inventor: Masayuki Nagano, Yokohama-shi (JP)

(21) Appl. No.: 19/690,078

(22) Filed: May 28, 2026

Related U.S. Application Data
(63) Continuation of application No. PCT/JP2024/035077, filed on Oct. 1, 2024.

(30) Foreign Application Priority Data
Dec. 25, 2023 (JP) 2023-217786

(51) Int. Cl. G06T 19/00

(52) U.S. Cl. CPC G06T 19/00; G06T 2219/024

(57) ABSTRACT

A virtual space control system is a virtual space control system that causes an information processing apparatus to display a virtual space and to display an avatar corresponding to a user in the virtual space displayed, and the information processing apparatus included in the virtual space control system performs, in a case where a state in which a second avatar corresponding to a second user has entered an information sharing range of a first avatar corresponding to a first user or an approaching state in which the second avatar is likely to enter the information sharing range is detected in the virtual space, display representing the second avatar at a position on a display screen of a first information terminal apparatus on which the first user is logged in to the virtual space, the position being exposed without being hidden by information displayed on the display screen.

### CROSS-REFERENCE TO RELATED APPLICATIONS

This application is a Continuation of PCT International Application No. PCT/JP2024/035077 filed on Oct. 1, 2024 which claims the benefit of priority from Japanese Patent Application No. 2023-217786, filed on Dec. 25, 2023, the entire contents of both of which are incorporated herein by reference.

### BACKGROUND OF THE INVENTION

### 1. Field of the Invention

The present invention relates to a virtual space control system, a virtual space control method, and a program.

### 2. Description of the Related Art

In a known technique related to a virtual office configured in a virtual space, each user performs work within the virtual office using an avatar (see, for example, Japanese Unexamined Patent Application Publication No. 2022-071314).

A known information sharing function enables sound, such as voice, to be audible to each other when a plurality of avatars are close to each other or are present in the same space, within a virtual space, such as a virtual office. Because a user of an avatar displays a virtual space on a display screen of an information terminal apparatus, for some work, a window displaying the virtual space may be minimized or displayed behind another window. In such a state, the user may fail to notice that an avatar of another user has approached the user.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A virtual space control system according to the present disclosure that causes an information terminal apparatus to display a virtual space and to display an avatar corresponding to a user in the virtual space, the virtual space control system comprising: an information processing apparatus that performs, in a case where a state in which a second avatar corresponding to a second user has entered an information sharing range of a first avatar corresponding to a first user or an approaching state in which the second avatar is likely to enter the information sharing range is detected in the virtual space, display representing the second avatar at a position on a display screen of a first information terminal apparatus on which the first user is logged in to the virtual space, the position being exposed without being hidden by information displayed on the display screen.

A virtual space control method according to the present disclosure executed by a virtual space control system that causes an information terminal apparatus to display a virtual space and to display an avatar corresponding to a user in the virtual space, the virtual space control method including: performing, in a case where a state in which a second avatar corresponding to a second user has entered an information sharing range of a first avatar corresponding to a first user or an approaching state in which the second avatar is likely to enter the information sharing range is detected in the virtual space, display representing the second avatar at a position on a display screen of a first information terminal apparatus on which the first user is logged in to the virtual space, the position being exposed without being hidden by information displayed on the display screen.

A program according to the present disclosure that causes a computer, which controls a space sharing system, to perform operation including: performing, in a case where a state in which a second avatar corresponding to a second user has entered an information sharing range of a first avatar corresponding to a first user or an approaching state in which the second avatar is likely to enter the information sharing range is detected in a virtual space, display representing the second avatar at a position on a display screen of a first information terminal apparatus on which the first user is logged in to the virtual space, the position being exposed without being hidden by information displayed on the display screen.

### BRIEF DESCRIPTION OF THE DRAWINGS

FIG. 1 is a schematic diagram illustrating an example of a configuration of a virtual space control system according to a first embodiment;

FIG. 2 is a block diagram illustrating an example of a configuration of an information terminal apparatus according to the first embodiment;

FIG. 3 is a block diagram illustrating an example of a configuration of a server apparatus according to the first embodiment;

FIG. 4 is a block diagram illustrating an example of a configuration of an information processing apparatus according to the first embodiment;

FIG. 5 is a diagram illustrating a display screen of the information terminal apparatus according to the first embodiment;

FIG. 6 is a diagram illustrating an example of a window of a virtual office displayed on the display screen in FIG. 5;

FIG. 7 is a diagram illustrating another example of the display screen of the information terminal apparatus according to the first embodiment;

FIG. 8 is a flowchart illustrating an example of a virtual space control method according to the first embodiment;

FIG. 9 is a flowchart illustrating another example of the virtual space control method according to the first embodiment;

FIG. 10 is a diagram illustrating an example of a display screen of an information terminal apparatus according to a second embodiment;

FIG. 11 is a diagram illustrating another example of the display screen of the information terminal apparatus according to the second embodiment;

FIG. 12 is a flowchart illustrating an example of a virtual space control method according to the second embodiment; and

FIG. 13 is a flowchart illustrating another example of the virtual space control method according to the second embodiment.

### DETAILED DESCRIPTION OF THE PREFERRED EMBODIMENTS

Embodiments of a virtual space control system, a virtual space control method, and a program, according to the present invention will be described in detail hereinafter by reference to the appended drawings. The present invention is not to be limited by the following embodiments.

### First Embodiment

### Virtual Space Control System

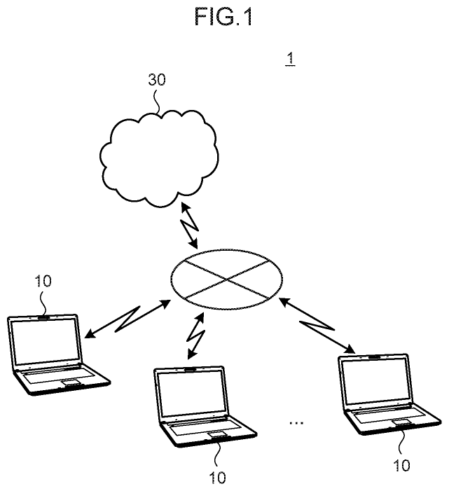

FIG. 1 is a schematic diagram illustrating an example of a configuration of a virtual space control system according to a first embodiment. A virtual space control system 1 controls a virtual office configured in a virtual space. With respect to the embodiment, the virtual office will be described hereinafter as an example, but without being limited to the virtual office, the virtual space control system 1 is applicable to various services for performing communication using avatars in a virtual space.

An overview of the virtual office controlled by the virtual space control system 1 will be described below. A user uses an information terminal apparatus to log in to a virtual office with the user's own account and to perform work. In the virtual office, an avatar associated with the user is set. In a case where the user logs in to the virtual office using an information terminal apparatus 10 used by the user and described later, user operation and display are performed to move the avatar to any seat or a predetermined seat in the virtual office and to seat the avatar there. The user is able to manipulate the avatar to move the avatar in the virtual office. For example, in a case where avatars are close to each other in the virtual office, or in a case where the avatars are located in the same space, such as a conference room, in the virtual office, information sharing is able to be performed such that sound, such as voice, is audible to each other.

The virtual space control system 1 includes: information terminal apparatuses 10 used for work by respective users; and a server apparatus 30.

### Information Terminal Apparatus

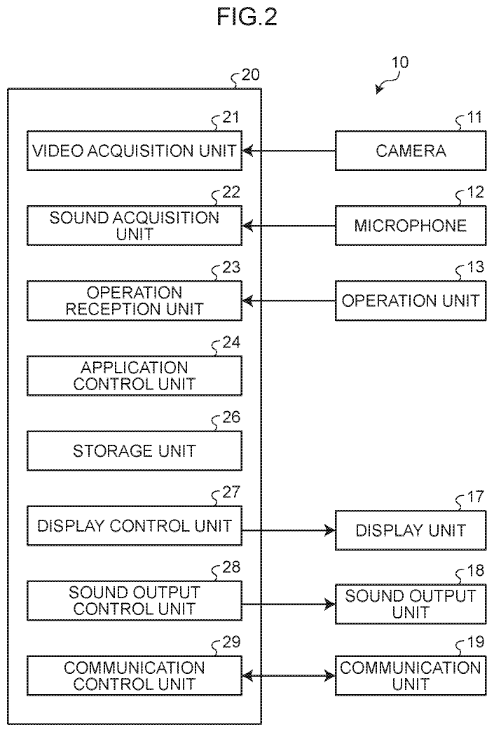

FIG. 2 is a block diagram illustrating an example of a configuration of an information terminal apparatus according to the first embodiment. The information terminal apparatuses 10 are each a terminal apparatus used by a user who performs work in the virtual office. The information terminal apparatuses 10 are each a terminal apparatus on which a user executes a virtual office application. The information terminal apparatuses 10 are each a terminal apparatus used by a user to log in to the virtual office with the user's own account.

The information terminal apparatuses 10 are each an information terminal apparatus, such as, for example, a general-purpose personal computer, a smartphone, or a tablet terminal. The information terminal apparatuses 10 are connected to the server apparatus 30 via a network so as to be capable of performing data communication.

On the basis of account information of a person logged in to an information terminal apparatus 10, the information terminal apparatus 10 acquires account user information of the information terminal apparatus 10.

The information terminal apparatuses 10 each include a camera 11, a microphone 12, an operation unit 13, a display unit 17, a sound output unit 18, a communication unit 19, and a terminal control device 20.

The camera 11 captures an image of a region opposite the information terminal apparatus 10. The camera 11 is arranged at a position at which the camera 11 captures an image of a region opposite the display unit 17 of the information terminal apparatus 10. That is, the camera 11 captures an image of a region in which a person using the information terminal apparatus 10 is present. The camera 11 is arranged, for example, around the display unit 17. The camera 11 outputs a captured video to a video acquisition unit 21 of the terminal control device 20.

The microphone 12 collects sound around the information terminal apparatus 10. The microphone 12 may collect sound in a region opposite the display unit 17 of the information terminal apparatus 10 and may be included in a headset connected to the information terminal apparatus 10. That is, the microphone 12 collects speech of a person using the information terminal apparatus 10 and ambient sound. The microphone 12 outputs sound information related to collected sound, to a sound acquisition unit 22 of the terminal control device 20.

The operation unit 13 is an input device capable of inputting various operation to the information terminal apparatus 10. The operation unit 13 outputs an operation signal corresponding to received input operation, to the terminal control device 20. The operation unit 13 includes, for example, a keyboard, a mouse, a touch panel arranged so as to overlap the display unit 17, a button, and/or a switch. The operation unit 13 is capable of receiving, for example, key input operation, click operation, or touch operation.

The operation unit 13 is capable of receiving operation to move the avatar corresponding to the user in the virtual office in any direction on a display screen of the display unit 17. For example, the operation unit 13 receives operation to move the user's avatar in the virtual office so that the avatar overlaps or becomes adjacent to another avatar on the display screen of the display unit 17.

Performing the operation to cause the user's avatar to overlap or to be adjacent to another avatar enables a video call or a voice call to be initiated between the users in the virtual office application. Whether a video call or a voice call is to be made may be set beforehand or set by the user's operation.

The display unit 17 displays various videos including characters and images. The display unit 17 includes, for example, a liquid crystal display or an organic electroluminescence (EL) display. The display unit 17 displays a video of the virtual office. In this embodiment, in a case where a video call is enabled, a video of a user of another avatar who makes the video call, in other words, a video captured by a camera 11 of an information terminal apparatus 10 used by the user of the other avatar is output on the display unit 17. Display on the display unit 17 is controlled by a display control unit 27.

The sound output unit 18 is a sound output device that outputs sound of the virtual office. In this embodiment, when the virtual office is being used, the sound output unit 18 outputs sound around the user's own avatar. Furthermore, in a case where a voice call or a video call is enabled, the sound output unit 18 outputs voice of a user of another avatar who makes the voice call or the video call, in other words, sound collected by a microphone 12 of an information terminal apparatus 10 used by the user of the avatar. Output of the sound by the sound output unit 18 is controlled by a sound output control unit 28.

The communication unit 19 is a communication unit for performing wired communication or wireless communication. For example, the communication unit 19 performs communication by using a communication method using Wi-Fi (registered trademark) or a mobile phone line, and is connected to an intranet or the Internet. Communication by the communication unit 19 is controlled by a communication control unit 29. The communication unit 19 performs communication of data, such as a video and sound, with the server apparatus 30. The communication unit 19 performs communication of data, such as account user information and application operation state information of the information terminal apparatus 10, with the server apparatus 30.

### Terminal Control Device

The terminal control device 20 controls each unit of the information terminal apparatus 10. The terminal control device 20 has, for example, a control device, such as a central processing unit (CPU) or a microprocessing unit (MPU), and a storage device, such as a random access memory (RAM) or a read only memory (ROM). The terminal control device 20 executes a program that controls operation of the information terminal apparatus 10 according to the present disclosure. The terminal control device 20 may be implemented by, for example, an integrated circuit, such as an ASIC or an FPGA. The terminal control device 20 loads a stored program into a memory and executes commands included in the program. The terminal control device 20 includes an internal memory, such as the RAM mentioned above, and the internal memory is used for temporary storage of data in the terminal control device 20. The terminal control device 20 may be implemented by a combination of hardware and software.

The terminal control device 20 has, as functional blocks implemented by circuits or executed programs, the video acquisition unit 21, the sound acquisition unit 22, an operation reception unit 23, an application control unit 24, a storage unit 26, the display control unit 27, the sound output control unit 28, and the communication control unit 29.

The video acquisition unit 21 acquires a video captured by the camera 11. More specifically, the video acquisition unit 21 acquires a video captured by the camera 11, the video including a person facing the information terminal apparatus 10. Video data acquired by imaging with the camera 11 correspond to a moving image.

The sound acquisition unit 22 acquires sound detected by the microphone 12. The sound acquisition unit 22 acquires sound, such as speech of a person present around the information terminal apparatus 10.

The operation reception unit 23 acquires, from the operation unit 13, an operation signal corresponding to operation on the operation unit 13. The operation reception unit 23 outputs a control signal corresponding to the operation signal acquired, to each unit.

The operation reception unit 23 receives operation on the display screen of the display unit 17. The operation reception unit 23 receives operation for moving the avatar of its user in the virtual office on the display screen of the display unit 17. For example, the operation reception unit 23 receives operation for causing its user's avatar in the virtual office to overlap or become adjacent to another avatar, on the display screen of the display unit 17.

The application control unit 24 controls operation of various applications executed on the information terminal apparatus 10. The application control unit 24 may control the operation of the various applications in cooperation with an application control unit 42 of the server apparatus 30 described later.

The application control unit 24 causes the display control unit 27 described later to perform display on the display unit 17, the display being related to an application running on the information terminal apparatus 10. The display related to the application is, for example, a window or an icon presented to the user of the information terminal apparatus 10.

When the user of the information terminal apparatus 10 is logged in to the virtual office, the application control unit 24 allows the virtual office executed by the application control unit 42 of the server apparatus 30 to be used on the information terminal apparatus 10. Furthermore, on the basis of an instruction from the application control unit 42 of the server apparatus 30, the application control unit 24 performs display representing another avatar at a position that is exposed without being hidden by information displayed on the display screen of the display unit 17.

In a case where the virtual office application is executed on the information terminal apparatus 10, the application control unit 24 performs information sharing using the display control unit 27 and the sound output control unit 28 on the basis of an information sharing range set around the avatar corresponding to the user of the information terminal apparatus 10. Furthermore, in a case where a video call with an avatar corresponding to another user is initiated when the virtual office application is executed on the information terminal apparatus 10, the application control unit 24 performs the video call using the display control unit 27 and the sound output control unit 28.

The application control unit 24 cause the communication control unit 29 to transmit, to the server apparatus 30, a display state of a window displaying the virtual office on the display unit 17 of the information terminal apparatus 10. The display state of the window displaying the virtual office is information indicating whether or not the window for displaying the virtual office is appropriately displayed.

The state in which the window displaying the virtual office is appropriately displayed is a state in which the window displaying the virtual office is displayed without being hidden behind information, such as another window, and the user of the information terminal apparatus 10 is able to confirm another avatar present around the user's own avatar. In a case where a range enabling the user of the information terminal apparatus 10 to confirm another avatar present around the user's own avatar is displayed even if part of the window displaying the virtual office is hidden by information, such as another window, the display state may be regarded as the state in which the window displaying the virtual office is appropriately displayed.

The state in which the window displaying the virtual office is not appropriately displayed is a state in which the window displaying the virtual office is hidden behind information, such as another window, and the user of the information terminal apparatus 10 is unable to confirm another avatar present around the user's own avatar. In a case where the user of the information terminal apparatus 10 is unable to confirm another avatar present around the user's own avatar because part of the window displaying the virtual office is hidden by information, such as another window, the display state is also regarded as the state in which the window displaying the virtual office is not appropriately displayed, in addition to a state in which the window displaying the virtual office is completely hidden by information, such as another window. In a case where the window displaying the virtual office is minimized by operation of the user of the information terminal apparatus 10, the display state is also regarded as the state in which the window displaying the virtual office is not appropriately displayed.

The application control unit 24 acquires positions and information sharing ranges of respective avatars in the virtual office and detects whether another avatar has entered or is likely to enter the information sharing range of any avatar.

The storage unit 26 stores, for example, information, such as processing performed by the terminal control device 20 and programs. The storage unit 26 includes, for example, a main storage device, such as a RAM or a ROM, and a storage device, such as an SSD or a hard disk drive (HDD).

The storage unit 26 stores, for example, programs and setting information related to applications used in the information terminal apparatus 10, the applications including the virtual office application.

The information sharing ranges set for the avatars in the virtual office and information sharing will be described below. In the virtual office, an information sharing range is set around each avatar. The information sharing range is a range in which information is able to be shared with a user of another avatar and in which information sharing is enabled between a plurality of users mutually included in each other's information sharing ranges. In an example of information sharing in an information sharing range, sound is mutually shared. In other words, the information sharing ranges are ranges in which sound, such as voice of users of respective avatars, is audible to a user of another avatar. Furthermore, the information sharing ranges are ranges in which sound, such as voice of a user of another avatar is audible to the users of the respective avatars. Information that is able to be shared in an information sharing range may be other information, such as a video and text, without being limited to sound. In an example described with respect to an information sharing range in this embodiment, sound is shared.

For example, in a case where a second avatar enters an information sharing range of a first avatar, a second user of the second avatar is able to hear sound of a first user of the first avatar. Furthermore, in a case where the second avatar is in the information sharing range of the first avatar and the first avatar is in an information sharing range of the second avatar, bidirectional sound sharing is performed, and each other's presence is thereby able to be sensed and, without performing any particular operation, conversation is enabled. Therefore, an information sharing range may alternatively be referred to as a sound sharing range. Specifically, in a case where the first avatar and the second avatar are mutually included in each other's information sharing ranges, sound acquired by a sound acquisition unit 22 of an information terminal apparatus 10 used by the first user of the first avatar is audible at an information terminal apparatus 10 used by the second user, and sound acquired by a sound acquisition unit 22 of the information terminal apparatus 10 used by the second user of the second avatar is audible at the information terminal apparatus 10 used by the first user.

Furthermore, a space in which information sharing is enabled between all of avatars present in a specific range, such as a conference room set in the virtual office, may be set. Except for such a space set as described above, an information sharing range is set for each avatar.

The information sharing range of each avatar is set to its initial size and shape upon start of use of the virtual office. The size and shape of the information sharing range of each avatar may be able to be changed by user operation.

The display control unit 27 controls display of various videos on the display unit 17. The display control unit 27 controls display of a video of the virtual office on the display unit 17. In this embodiment, in a case where shared information includes a video and text, the display unit 17 is caused to output the video and text. In a case where a video call is enabled, the display control unit 27 causes the display unit 17 to output a video of a user of an avatar in the virtual office.

The sound output control unit 28 controls output of sound by the sound output unit 18. In a case where information sharing is being performed, the sound output control unit 28 causes the sound output unit 18 to output speech voice of a user of another avatar present in an information sharing range in the virtual office. In a case where a video call is enabled, the sound output control unit 28 causes the sound output unit 18 to output speech voice of a user who is a partner of the video call.

The communication control unit 29 controls the communication unit 19 to control transmission and reception of data, such as videos and sound, and transmission and reception of application operation state information, to and from the server apparatus 30. More specifically, for example, the communication control unit 29 controls the communication unit 19 to receive a video and sound of the virtual office from the server apparatus 30. For example, the communication control unit 29 controls the communication unit 19 to transmit, to the server apparatus 30, a video and sound of a person facing the display unit 17 of the information terminal apparatus 10, the video and sound being acquired by the video acquisition unit 21 and the sound acquisition unit 22. The application operation state information is, for example, for the virtual office application, operation of an avatar, operation for starting a video call, or operation for ending the video call, using the operation unit 13.

### Server Apparatus

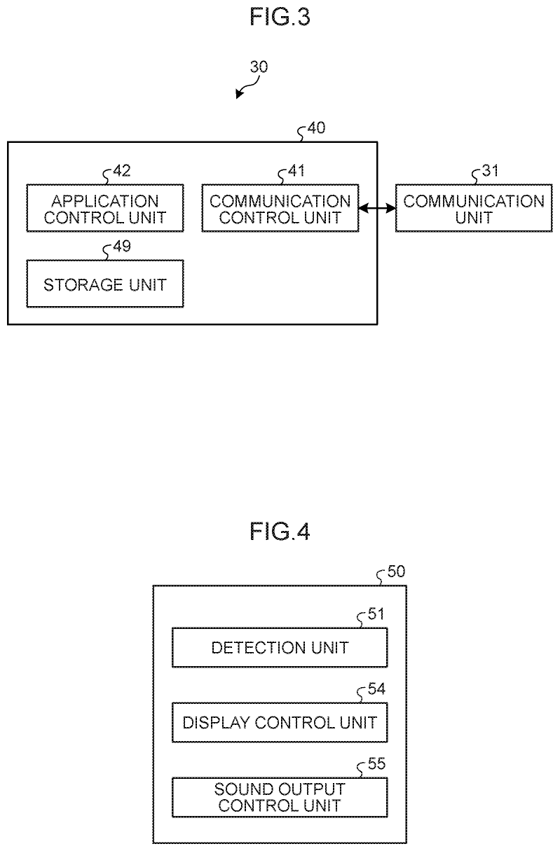

FIG. 3 is a block diagram illustrating an example of a configuration of a server apparatus according to the first embodiment. The server apparatus 30 is a server apparatus of a company to which a user of each information terminal apparatus 10 belongs or a server apparatus of an entity that provides a virtual office service, and may be a general-purpose server apparatus including a distributed configuration. The server apparatus 30 constructs and controls a virtual space, such as a virtual office. The server apparatus 30 includes a communication unit 31 and a server control device 40.

The communication unit 31 is a communication unit for performing wired communication or wireless communication. For example, the communication unit 31 performs communication by using a communication method using Wi-Fi (registered trademark) or a mobile phone line, and is connected to an intranet or the Internet. Communication by the communication unit 31 is controlled by a communication control unit 41. The communication unit 31 performs communication of data, such as videos and sound, and application operation state information, with a plurality of information terminal apparatuses 10.

### Server Control Device

The server control device 40 controls each unit of the server apparatus 30. The server control device 40 has, for example, a control device, such as a CPU or an MPU, and a storage device, such as a RAM or a ROM. The server control device 40 may be implemented by, for example, an integrated circuit, such as an ASIC or an FPGA. The server control device 40 may be implemented by a combination of hardware and software. The server control device 40 executes a program that controls operation of the server apparatus 30 according to the present disclosure.

The server control device 40 includes, as functional blocks implemented by circuits and executed programs, the communication control unit 41, the application control unit 42, and a storage unit 49.

The communication control unit 41 controls the communication unit 31 to control transmission and reception of data including videos and sound and transmission and reception of application operation state information, to and from the information terminal apparatuses 10. For example, the communication control unit 41 controls the communication unit 31 to receive videos captured by the cameras 11 of the information terminal apparatuses 10 and sound collected by their microphones 12, from the information terminal apparatuses 10. For example, the communication control unit 41 controls the communication unit 31 to transmit a video and sound of the virtual office to the information terminal apparatuses 10. The application operation state information includes, for example, configuration information for the virtual office application.

The application control unit 42 controls operation of various applications that operate on the server apparatus 30. The application control unit 42 controls, for example, operation of the virtual office application. The application control unit 42 controls, for example, operation of an application used for online communication.

The application control unit 42 transmits, by means of the communication control unit 41, a configuration of an application running on the server apparatus 30, to an information terminal apparatus 10 executing the application. Specifically, the application control unit 42 transmits information indicating a configuration of the virtual office running on the server apparatus 30, to an information terminal apparatus 10 logged in to the virtual office.

The storage unit 49 stores, for example, information, such as processing performed by the server control device 40 and programs. The storage unit 49 includes, for example, a main storage device, such as a RAM or a ROM, and a storage device, such as an SSD or an HDD.

The storage unit 49 stores information representing a virtual office configured in a virtual space. The storage unit 49 stores, for each user who logs in to the virtual office, information indicating an avatar, an information terminal apparatus 10 associated with the avatar, and an account user of the information terminal apparatus 10. The storage unit 49 may store, for each user, organization information indicating a department to which the user belongs or employment position information indicating an employment position of the user. The storage unit 49 stores information indicating an arrangement of objects constituting the virtual office, such as sections and virtual desks included in the virtual office.

### Information Processing Apparatus

An example of a configuration of an information processing apparatus according to the first embodiment will be described using FIG. 4. FIG. 4 is a block diagram illustrating the example of the configuration of the information processing apparatus according to the first embodiment. An information processing apparatus 50 is a conceptual apparatus implemented through cooperation of any one or both of the server apparatus 30 and the plurality of information terminal apparatuses 10 used in the virtual office. Either the information terminal apparatuses 10 or the server apparatus 30 may serve as the information processing apparatus 50, or an information processing system 1 including the information terminal apparatuses 10 and the server apparatus 30 may serve as the information processing apparatus 50. Each unit of the information processing apparatus 50 is implemented by cooperation of any one or both of the terminal control devices 20 and the server control device 40.

In a case where the information processing apparatus 50 detects that a second avatar corresponding to a second user is in in an approaching state relative to a first avatar corresponding to a first user in the virtual office, the information processing apparatus 50 displays an icon image representing the second avatar at a position on a display screen of a first information terminal apparatus (hereinafter referred to as the “first information terminal apparatus 10”) on which the first user is logged in to the virtual office, the position being exposed without being hidden by information, such as a window displayed on the display screen.

The approaching state is a state in which the second avatar corresponding to the second user has entered or is likely to enter an information sharing range of the first avatar corresponding to the first user.

The state in which the second avatar has entered the information sharing range of the first avatar is a state in which the second avatar has moved from outside to inside the information sharing range of the first avatar.

The state in which the second avatar is likely to enter the information sharing range of the first avatar is a state in which the second avatar is moving in a direction toward the information sharing range of the first avatar and has approached within a predetermined distance from the information sharing range of the first avatar. Specifically, it is a state in which the second avatar is moving toward the information sharing range of the first avatar and the position of the second avatar has approached within a predetermined distance, such as within 1 to 2 times the radius of the first avatar's information sharing range centered on the first avatar.

As illustrated in FIG. 4, the information processing apparatus 50 includes a detection unit 51, a display control unit 54, and a sound output control unit 55.

The detection unit 51 detects that the second avatar corresponding to the second user is in the approaching state relative to the first avatar corresponding to the first user, in the virtual office. When the second avatar is in the approaching state relative to the first avatar, sound, such as speech, of the user of the first avatar is audible or is in an audible state.

In this embodiment, the detection unit 51 may detect, as the approaching state, a state in which the second avatar corresponding to the second user belonging to an organization different from that of the first user has entered or is likely to enter the information sharing range of the first avatar.

In this embodiment, the detection unit 51 may detect, as the approaching state, a state in which the second avatar corresponding to the second user holding an employment position different from that of the first user has entered or is likely to enter the information sharing range of the first avatar.

The employment position different from that of the first user is, for example, an employment position that is superior to that of the first user who holds a general staff position. The employment position different from that of the first user is, for example, an employment position that is superior to that of another avatar group present in the same virtual office as the first user. The employment position different from that of the first user is, for example, an employment position that is subordinate to the first user who is an executive or a department head. The employment position different from that of the first user is, for example, an employment position that is subordinate to that of an avatar group present in the same virtual office as the first user.

The detection unit 51 detects the second avatar who has exited the information sharing range of the first avatar in the virtual office. In a case where the detection unit 51 in the information processing apparatus 50 detects that the second avatar has exited the information sharing range of the first avatar, sound, such as speech of the first user is inaudible to the second user.

In a case where the information processing apparatus 50 is implemented in an information terminal apparatus 10, the detection unit 51 may detect the second user for the first user who is logged in to the information terminal apparatus 10. In a case where the information processing apparatus 50 is implemented in the server apparatus 30, the detection unit 51 may detect second users respectively for all users.

The display control unit 54 causes the display units 17 of the plurality of information terminal apparatuses 10 to each display a video representing various information including a virtual office screen.

In a case where the detection unit 51 detects that the second avatar is in the approaching state relative to the first avatar, the display control unit 54 causes an icon image representing the second avatar to be displayed at a position on the display screen of the first information terminal apparatus 10 on which the first user is logged in to the virtual office, the position being exposed without being hidden by information, such as a window displayed on the display screen.

The position that is exposed without being hidden by information, such as a window displayed on the display screen, is, for example, an outer peripheral portion at the top, bottom, left, and/or right of the display screen of the display unit 17. The position that is exposed without being hidden by information, such as a window displayed on the display screen, is, for example, an area on the display screen, the area being where no information, such as a window, is displayed and a background image is visible.

In a case where a video call is enabled, the display control unit 54 cause videos of each other's faces to be mutually displayed on the information terminal apparatus 10 used by the first user corresponding to the first avatar and the information terminal apparatus 10 on which the second user corresponding to the second avatar is logged in to the virtual office (hereinafter referred to as the “second information terminal apparatus 10”). More specifically, the display control unit 54 causes the display unit 17 of the first information terminal apparatus 10 to output a video of the second user captured by the camera 11 of the second information terminal apparatus 10, and causes the display unit 17 of the second information terminal apparatus 10 to output a video of the first user captured by the camera 11 of the first information terminal apparatus 10.

In a case where a video call is terminated, the display control unit 54 stops video sharing between the first user and the second user.

In a case where the second avatar has entered the information sharing range of the first avatar, the sound output control unit 55 enables sound of the first user to be shared with the second user. Furthermore, in a case where the first avatar is in the information sharing range of the second avatar in a state in which the second avatar is in the information sharing range of the first avatar, the sound output control unit 55 enables sound of the first user to be shared with the second user and enables sound of the second user to be shared with the first user. In other words, the first user and the second user become capable of sharing sound with each other, thereby enabling voice-based conversation. More specifically, in a case where sound sharing is enabled, the sound output control unit 55 causes sound, such as voice, to be mutually audible at the information terminal apparatus 10 used by the first user corresponding to the first avatar and the second information terminal apparatus 10 on which the second user corresponding to the second avatar is logged in to the virtual office. More specifically, the sound output control unit 55 causes sound of the second user collected by the microphone 12 of the second information terminal apparatus 10 to be output from the sound output unit 18 of the first information terminal apparatus 10, and causes sound of the first user collected by the microphone 12 of the first information terminal apparatus 10 to be output from the sound output unit 18 of the second information terminal apparatus 10.

In a case where the first avatar and the second avatar are no longer included in the information sharing ranges due to, for example, movement of the avatars, the sound output control unit 55 stops the sound sharing between the first user and the second user.

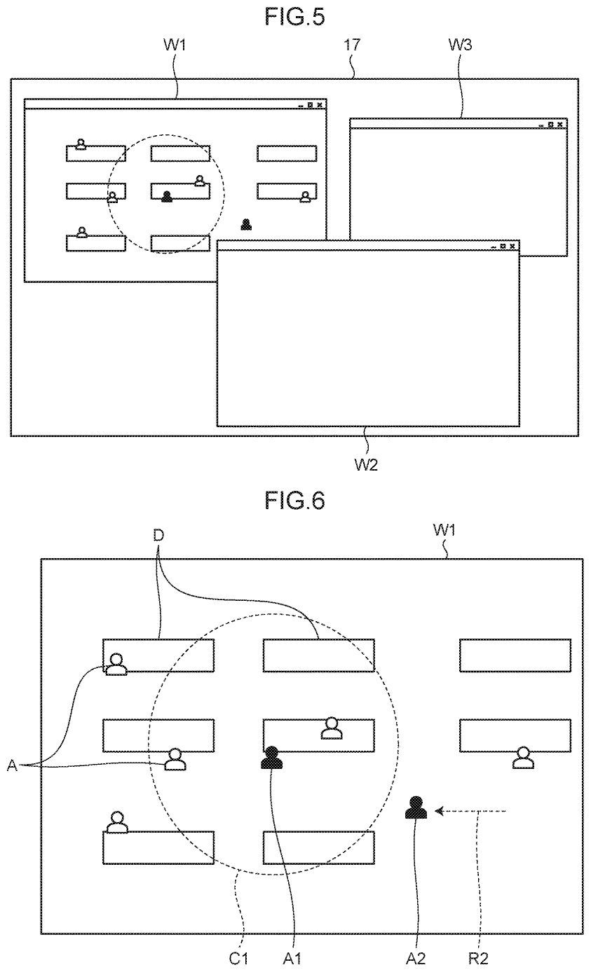

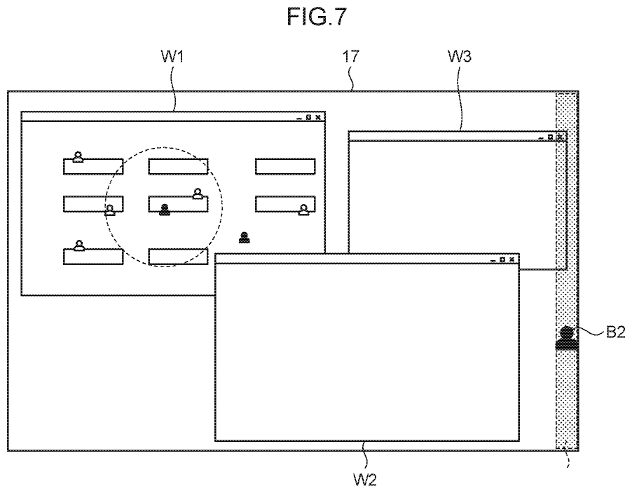

The display screen on the display unit 17 of the first information terminal apparatus 10 used by the first user who is logged in to the virtual office will be described using FIG. 5 to FIG. 7. FIG. 5 is a diagram illustrating an example of the display screen on the display unit 17 of the information terminal apparatus according to the first embodiment. FIG. 6 is a diagram illustrating an example of a window of the virtual office displayed on the display screen of FIG. 5. FIG. 7 is a diagram illustrating another example of the display screen of the information terminal apparatus according to the first embodiment. As illustrated in FIG. 5, for example, a window W1 for displaying a virtual office screen by the virtual office application, a window W2 of another application, and a window W3 are displayed on the display unit 17 of the first information terminal apparatus 10. In the example illustrated in FIG. 5, the window W1 is displayed behind the window W2.

FIG. 6 is an enlarged view of the window W1 of FIG. 5. As illustrated in FIG. 6, a video of the virtual office is displayed in the window W1 for displaying the virtual office. A plurality of virtual desks D are arranged and a plurality of avatars A are present, in the virtual office. FIG. 6 illustrates a state in which a second avatar A2 has moved in the direction of an arrow R2 from an adjacent section that is outside the display range of the virtual office displayed on the information terminal apparatus 10 of the first user and that is not displayed on the information terminal apparatus 10 of the first user. This case is a state in which the second avatar A2 is likely to enter an information sharing range C1 of a first avatar A1.

As illustrated in FIG. 7, display B2 indicating the presence of the second avatar A2 is performed in an outer peripheral portion of the display screen, the outer peripheral portion being at a position that is exposed without being hidden by a window on the display screen of the information terminal apparatus 10 of the first user.

In a case where the second avatar A2 is likely to enter the information sharing range C1 of the first avatar A1, as illustrated in FIG. 6, the display B2 indicating the presence of the second avatar A2 may be performed using an image and/or text indicating that the second avatar A2 is likely to enter. In a case where the second avatar A2 has entered the information sharing range C1 of the first avatar A1, although this state is not illustrated in the drawings, display using an image and/or text indicating that the second avatar A2 has entered may be performed.

### Virtual Space Control Method

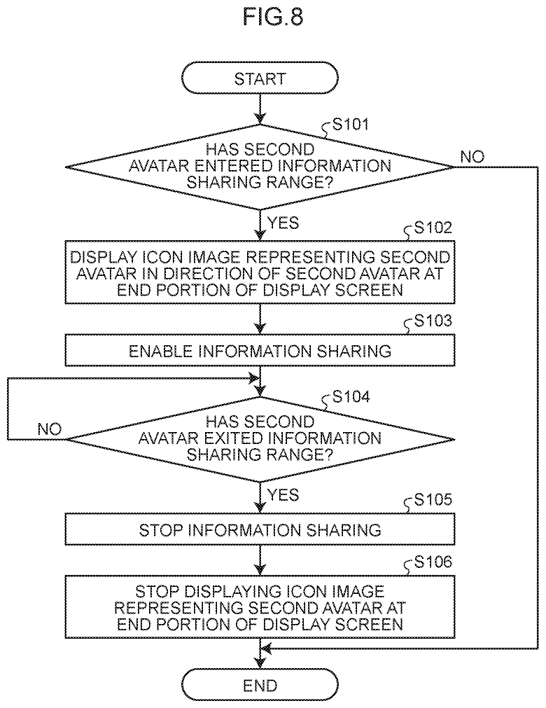

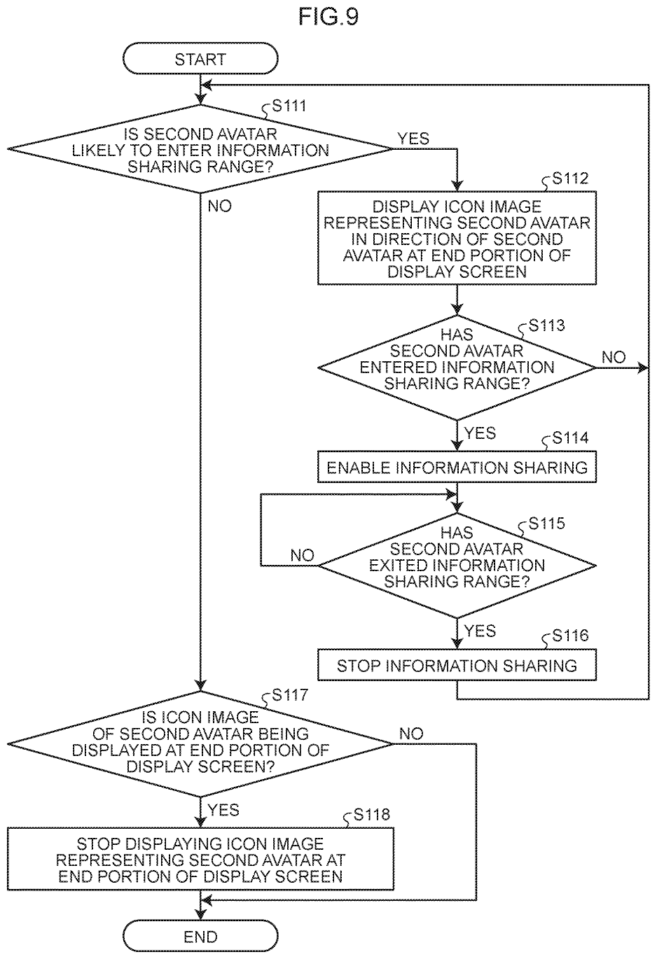

A virtual space control method will be described by use of FIG. 8 and FIG. 9. FIG. 8 is a flowchart illustrating an example of a virtual space control method according to the first embodiment. Processing illustrated in FIG. 8 is executed while the virtual office is being provided by the virtual space control system 1. In a case where the information processing apparatus 50 is implemented in an information terminal apparatus 10, processing of flowcharts illustrated in FIG. 8 and FIG. 9 may be executed for the first user who has logged in to the information terminal apparatus 10. In a case where the information processing apparatus 50 is implemented in the server apparatus 30, the processing of the flowcharts illustrated in FIG. 8 and FIG. 9 may be executed for all of users.

The information processing apparatus 50 determines whether or not the second avatar has entered the information sharing range of the first avatar (Step S101). More specifically, the information processing apparatus 50 detects, by means of the detection unit 51, the second avatar who has entered the information sharing range of the first avatar, in the virtual office. In a case where the information processing apparatus 50 determines that the second avatar has entered the information sharing range of the first avatar (Yes at Step S101), the information processing apparatus 50 proceeds to Step S102. In a case where the information processing apparatus 50 determines that the second avatar has not entered the information sharing range of the first avatar (No at Step S101), the processing of this flowchart is ended.

In a case where it is determined that the second avatar has entered the information sharing range of the first avatar (Yes at Step S101), the information processing apparatus 50 displays an icon image representing the second avatar at an end portion of the display screen of the display unit 17 of the first information terminal apparatus 10, the end portion being in the direction of the second avatar as seen from the first avatar (Step S102). The information processing apparatus 50 proceeds to Step S103.

The information processing apparatus 50 enables sound sharing (Step S103). More specifically, by means of the sound output control unit 55, the information processing apparatus 50 causes sound, such as voice, to be mutually audible at the first information terminal apparatus 10 and the second information terminal apparatus 10. The information processing apparatus 50 proceeds to Step S104.

The information processing apparatus 50 determines whether or not the second avatar has exited the information sharing range of the first avatar (Step S104). More specifically, the information processing apparatus 50 detects, by means of the detection unit 51, that the second avatar has exited the information sharing range of the first avatar, in the virtual office. In a case where the information processing apparatus 50 determines that the second avatar has exited the information sharing range of the first avatar (Yes at Step S104), the information processing apparatus 50 proceeds to Step S105. In a case where the information processing apparatus 50 determines that the second avatar has not exited the information sharing range of the first avatar (No at Step S104), the information processing apparatus 50 executes the processing of Step S104 again.

In a case where it is determined that the second avatar has exited the information sharing range of the first avatar (Yes at Step S104), the information processing apparatus 50 stops the sound sharing (Step S105). More specifically, by means of the sound output control unit 55, the information processing apparatus 50 stops the sound sharing between the first information terminal apparatus 10 and the second information terminal apparatus 10. The information processing apparatus 50 proceeds to Step S106.

The information processing apparatus 50 stops the display of the icon image representing the second avatar at the end portion of the display screen of the display unit 17 of the first information terminal apparatus 10, the end portion being in the direction of the second avatar (Step S106). The information processing apparatus 50 ends the processing of this flowchart.

FIG. 9 is a flowchart illustrating another example of the virtual space control method according to the first embodiment. Processing illustrated in FIG. 9 is executed while the virtual office is being provided by the virtual space control system 1. Processing similar to that at Step S102, Step S101, Step S103 to Step S105, and Step S106 in FIG. 8 is performed at Step S112, Step S113, Step S114 to Step S116, and Step S118 in FIG. 9.

The information processing apparatus 50 determines whether or not the second avatar is likely to enter the information sharing range of the first avatar (Step S111). More specifically, the information processing apparatus 50 detects, by means of the detection unit 51, the second avatar who is likely to enter the information sharing range of the first avatar, in the virtual office. In a case where the information processing apparatus 50 determines that the second avatar is likely to enter the information sharing range of the first avatar (Yes at Step S111), the information processing apparatus 50 proceeds to Step S112. In a case where the information processing apparatus 50 determines that the second avatar is not likely to enter the information sharing range of the first avatar (No at Step S111), the information processing apparatus 50 proceeds to Step S117.

The information processing apparatus 50 determines whether or not an icon image of the second avatar is being displayed at an end portion of the display screen of the display unit 17 of the first information terminal apparatus 10 (Step S117). In a case where the information processing apparatus 50 determines that the icon image of the second avatar is being displayed at the end portion of the display screen of the display unit 17 of the first information terminal apparatus 10 (Yes at Step S117), the information processing apparatus 50 proceeds to Step S118. A case where the result is Yes at Step S117 is a case where the processing has proceeded to the determination of Step S117 via Step S116 after obtaining Yes at Step S111. A case where the result is No at Step S117 is a case where the result is No at Step S111 without going through the processing from Step S112 to Step S116, or a case where the processing is started again after the processing of Step S118 and the result is No at Step S111. In a case where the information processing apparatus 50 determines that an icon image of the second avatar is not being displayed at the end portion of the display screen of the display unit 17 of the first information terminal apparatus 10 (No at Step S117), the information processing apparatus 50 ends the processing of this flowchart.

### Effects

As described above, in this embodiment, in a case where the second avatar is detected to be in the approaching state relative to the information sharing range of the first avatar in the virtual office, display representing the second avatar is able to be performed at a position exposed without being hidden by a window, on the display screen of the first information terminal apparatus 10. The embodiment enables the first user to confirm the approach of the second avatar of the second user even if the window of the virtual office screen is minimized or is displayed behind another window, on the display screen of the information terminal apparatus 10. The embodiment enables the first user to notice that the second avatar has entered or is likely to enter the information sharing range of the first avatar. The embodiment enables appropriate display of approach of another user's avatar in a virtual space, such as a virtual office.

Accordingly, in this embodiment, for example, when the first user is having a highly confidential conversation to be kept confidential from the second user, by confirming that the second avatar is approaching, the first user is able to interrupt the highly confidential conversation or ask the second user to wait.

This embodiment enables the first user to notice that the second avatar has entered or is likely to enter the information sharing range of the first avatar, and a situation in which the first user is suddenly spoken to by the second user in close proximity, or a situation in which a voice call is suddenly requested is thus able to be prevented.

This embodiment enables the first user to notice that the second avatar has entered or is likely to enter the information sharing range of the first avatar, and the first user is thus able to prepare for communication with the second user, by, for example, saving documents being worked on, minimizing a window corresponding to the documents, or presenting materials to be used for communication with the second user. Furthermore, this embodiment allows the first user to be well-prepared to respond to the second user.

This embodiment enables detection of a state in which the second avatar corresponding to the second user belonging to an organization different from that of the first user has entered or is likely to enter the information sharing range of the first avatar. The embodiment enables the first user to notice the approach of the second user who belongs to an organization different from that of the first user and from whom information is highly likely to be required to be kept confidential. In this embodiment, for example, when the first user is having a highly confidential conversation to be kept confidential from the second user, by confirming that the second avatar is approaching, the first user is able to interrupt the highly confidential conversation or ask the second user to wait.

The embodiment enables detection of the state in which the second avatar corresponding to the second user who holds an employment position different from that of the first user has entered or is likely to enter the information sharing range of the first avatar. In this embodiment, for example, when the first user is having a highly confidential conversation to be kept confidential from the second user, by confirming that the second avatar is approaching, the first user is able to interrupt the highly confidential conversation or ask the second user to wait.

### Second Embodiment

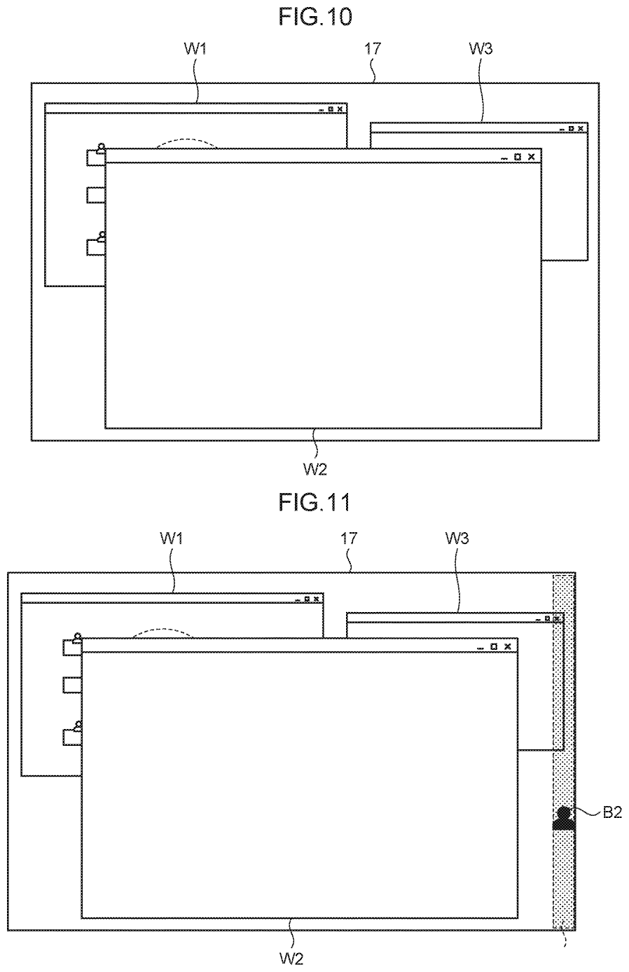

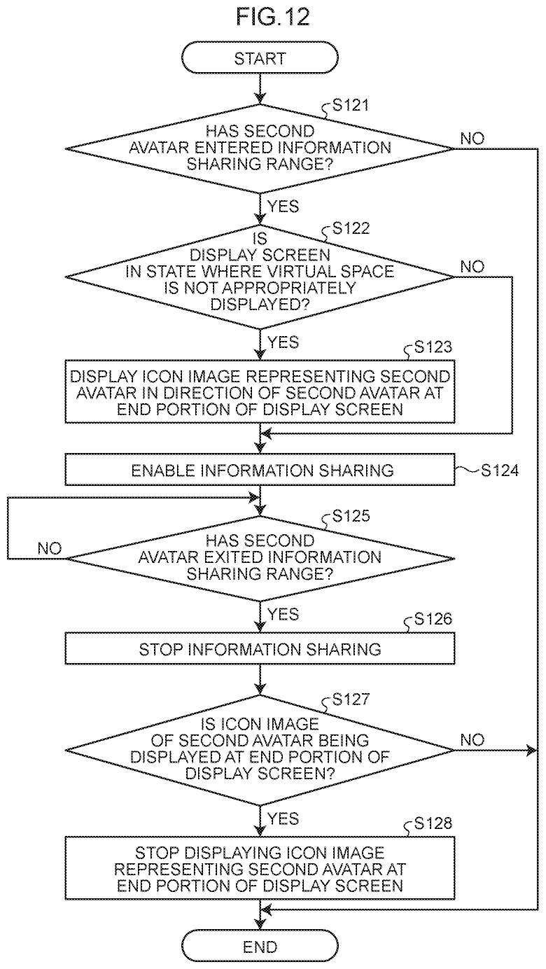

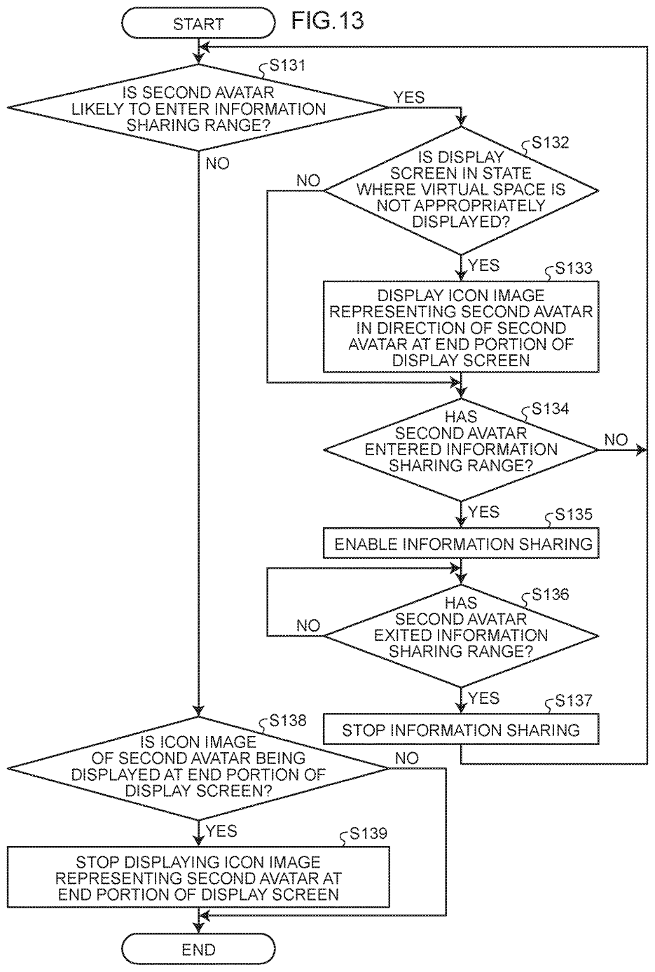

A virtual space control system 1 according to a second embodiment will be described by use of FIG. 10 to FIG. 13. FIG. 10 is a diagram illustrating an example of a display screen of an information terminal apparatus according to the second embodiment. FIG. 11 is a diagram illustrating another example of the display screen of the information terminal apparatus according to the second embodiment. FIG. 12 is a flowchart illustrating an example of a virtual space control method according to the second embodiment. FIG. 13 is a flowchart illustrating another example of the virtual space control method according to the second embodiment. In the following description, the same reference sign or a corresponding reference sign will be assigned to any component that is similar to that of the virtual space control system 1 of the first embodiment, and detailed description thereof will be omitted. Processing executed by an information processing apparatus 50 of the virtual space control system 1 is different from that of the first embodiment.

In a case where the information processing apparatus 50 detects that a second avatar is in an approaching state relative to a first avatar in a virtual office, the information processing apparatus 50 displays an icon image representing the second avatar in the direction of the second avatar with reference to the position of the first avatar in the virtual office on a display screen of a first information terminal apparatus 10.

In a state in which a window displaying the virtual office is hidden on the display screen of the first information terminal apparatus 10, the information processing apparatus 50 displays the icon image representing the second avatar in an outer peripheral portion of the display screen of the first information terminal apparatus 10. In other words, in a state in which the window displaying the virtual office is not appropriately displayed on the display screen of the first information terminal apparatus 10, the information processing apparatus 50 displays the icon image representing the second avatar in the outer peripheral portion of the display screen of the first information terminal apparatus 10.

The state in which the window displaying the virtual office is not appropriately displayed is a state in which the window displaying the virtual office is hidden by information, such as another window, or is minimized, as described above.

The outer peripheral portion is, for example, an upper end portion, a lower end portion, a right end portion, and a left end portion, of the display screen.

In a case where a detection unit 51 detects that the second avatar is in the approaching state relative to the first avatar, a display control unit 54 causes the icon image representing the second avatar to be displayed in the direction of the second avatar with reference to the position of the first avatar in the virtual office on the display screen of the first information terminal apparatus 10 on which the first user is logged in to the virtual office.

In a case where the detection unit 51 detects that the second avatar is in the approaching state relative to the first avatar, the display control unit 54 causes the icon image representing the second avatar to be displayed in the outer peripheral portion of the display screen of the first information terminal apparatus 10 on which the first user is logged in to the virtual office.

The display screen on a display unit 17 of the first information terminal apparatus 10 used by the first user who is logged in to the virtual office will be described using FIG. 10 and FIG. 11. As illustrated in FIG. 10, a window W1 displaying a virtual office screen is displayed hidden behind a window W2 on the display unit 17 of the first information terminal apparatus 10. The window W1 is similar to that in FIG. 6.

As illustrated in FIG. 11, display B2 indicating presence of a second avatar A2 is displayed in the direction of the second avatar with reference to the first avatar. Specifically, as illustrated in FIG. 6, in the window W1 displayed hidden behind the window W2 in FIG. 11, the second avatar A2 is likely to enter an area in the lower right of an information sharing range C1 with respect to the position of a first avatar A1. Therefore, the icon B2 representing the second avatar is displayed at a lower right position in the outer peripheral portion of the display screen of the display unit 17 of the first information terminal apparatus 10.

### Virtual Space Control Method

The virtual space control method will be described by use of FIG. 12 and FIG. 13. Processing similar to that of Step S101, Step S102 to Step S105, and Step S106 in FIG. 8 is performed at Step S121, Step S123 to Step S126, and Step S128 in FIG. 12. Processing similar to that of Step S117 in FIG. 9 is performed at Step S127 in FIG. 12.

The information processing apparatus 50 determines whether or not the display screen of the display unit 17 of the first information terminal apparatus 10 is in a state in which a window displaying a virtual office is not appropriately displayed (Step S122). In a case where the information processing apparatus 50 determines that the display screen of the display unit 17 of the first information terminal apparatus 10 is in the state in which the window displaying the virtual office is not appropriately displayed (Yes at Step S122), the information processing apparatus 50 proceeds to Step S123. In a case where the information processing apparatus 50 determines that the display screen of the display unit 17 of the first information terminal apparatus 10 is not in the state in which the window displaying the virtual office is not appropriately displayed (No at Step S122), the information processing apparatus 50 proceeds to Step S124.

Processing similar to that of Step S111 and Step S112 to Step S118 in FIG. 9 is performed at Step S131 and Step S133 to Step S139 in FIG. 13. Processing similar to that of Step S122 in FIG. 12 is performed at Step S132 in FIG. 13.

### Effects

As described above, in this embodiment, display indicating presence of the second avatar A2 is able to be performed in the direction of the second avatar A2 with reference to the position of the first avatar A1. Because the display is performed at the position corresponding to the direction from which the second avatar A2 comes, the embodiment enables the first user to confirm from which direction the second avatar has come in the virtual office. In a case where the first user has anticipated the arrival of the second avatar, the direction of the anticipated second avatar is predicted, and the embodiment thus allows the first user to intuitively recognize that the anticipated second avatar has come. According to this embodiment, even in a case where the arrival of the second avatar has not been anticipated, knowing the direction from which the second avatar has come may allow the first user to anticipate to some extent as to which user's second avatar has come.

In this embodiment, in a state in which a window displaying a virtual office on the display screen of the first information terminal apparatus 10 is hidden, that is, in a state in which the window displaying the virtual office is not appropriately displayed, display representing the second avatar may be performed in the outer peripheral portion of the display screen of the first information terminal apparatus 10. In a state in which the first user is unable to confirm the presence of another avatar present around the first avatar on the display screen, the embodiment enables the first user to notice that another avatar has entered or is likely to enter the information sharing range of the first avatar.

A virtual space control system, a virtual space control method, and a program, according to the present disclosure are able to be used for, for example, a communication system for performing communication using avatars in a virtual space, such as a virtual office.

According to the present disclosure, a user is able to be appropriately notified that an avatar of another user has approached the user in a virtual space.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A virtual space control system that causes an information terminal apparatus to display a virtual space and to display an avatar corresponding to a user in the virtual space, the virtual space control system comprising:
an information processing apparatus that performs, in a case where a state in which a second avatar corresponding to a second user has entered an information sharing range of a first avatar corresponding to a first user or an approaching state in which the second avatar is likely to enter the information sharing range is detected in the virtual space, display representing the second avatar at a position on a display screen of a first information terminal apparatus on which the first user is logged in to the virtual space, the position being exposed without being hidden by information displayed on the display screen.

2. The virtual space control system according to claim 1, wherein the information processing apparatus performs, in a case where the approaching state is detected in the virtual space, the display representing the second avatar in a direction of the second avatar with reference to a position of the first avatar in the virtual space.

3. The virtual space control system according to claim 1, wherein in a state in which a window displaying the virtual space on the display screen of the first information terminal apparatus is hidden, the information processing apparatus performs the display representing the second avatar in an outer peripheral portion of the display screen of the first information terminal apparatus.

4. The virtual space control system according to claim 1, wherein the information processing apparatus performs, in a case where the second avatar corresponding to the second user who belongs to an organization different from that of the first user is detected to be in the approaching state, the display representing the second avatar at the position exposed without being hidden by the information displayed on the display screen of the first information terminal apparatus.

5. The virtual space control system according to claim 1, wherein the information processing apparatus performs, in a case where the second avatar corresponding to the second user who holds an employment position different from that of the first user is detected to be in the approaching state, the display representing the second avatar at the position exposed without being hidden by the information displayed on the display screen of the first information terminal apparatus.

6. A virtual space control method executed by a virtual space control system that causes an information terminal apparatus to display a virtual space and to display an avatar corresponding to a user in the virtual space, the virtual space control method including:
performing, in a case where a state in which a second avatar corresponding to a second user has entered an information sharing range of a first avatar corresponding to a first user or an approaching state in which the second avatar is likely to enter the information sharing range is detected in the virtual space, display representing the second avatar at a position on a display screen of a first information terminal apparatus on which the first user is logged in to the virtual space, the position being exposed without being hidden by information displayed on the display screen.

7. A non-transitory computer-readable storage medium storing a program causing a computer, which controls a space sharing system to execute:
performing, in a case where a state in which a second avatar corresponding to a second user has entered an information sharing range of a first avatar corresponding to a first user or an approaching state in which the second avatar is likely to enter the information sharing range is detected in a virtual space, display representing the second avatar at a position on a display screen of a first information terminal apparatus on which the first user is logged in to the virtual space, the position being exposed without being hidden by information displayed on the display screen.
